(19) United States
(12) Patent Application Publication
(10) Pub. No.: US 2011/0292057 A1
(43) Pub. Date: Dec. 1, 2011

(54) Dynamic Bandwidth Determination and Processing Task Assignment for Video Data Processing

(75) Inventors: Michael L. Schmit, Cupertino, CA (US); Radha Giduthuri, Campbell, CA (US)

(73) Assignee: ADVANCED MICRO DEVICES, INC., Sunnyvale, CA (US)

(21) Appl. No.: 12/788,259

(22) Filed: May 26, 2010

(51) Int. Cl. G06F 13/14; G06F 12/02

(52) U.S. Cl. 345/520; 345/543

(57) ABSTRACT

A method and apparatus for dynamic bandwidth determination and processing task assignment is disclosed. Embodiments include a video driver/interface that communicates with a video processing application such as a video editor. The video driver/interface is configurable to determine a best configuration of the system in order optimally perform the chosen video processing task. Configuration of a system includes dividing the task into subtasks and assigning the subtasks to processors of the system, including central processing units (CPUs) and graphics processing units (GPUs). Configuration of the system also includes optimizing use of available memory of different kinds.

### TECHNICAL FIELD

The disclosed embodiments relate generally to video data processing, display technology, and more specifically to methods and systems optimizing system usage for various video data processing tasks.

### BACKGROUND OF THE DISCLOSURE

There are many possible hardware and software configurations for performing video data processing tasks. For example, a laptop computer can be used to transcode video data for uploading to an Internet application like YouTube. The same video data can also be edited using a movie studio quality editing system to produce a very high definition video output. Different configurations include various processors with different speeds and memory components, or address spaces with different access speeds. Processing tasks are varied as well, and include editing, decoding (dual and single), encoding (dual and single), blending, transcoding, scaling, and more. Consumers today desire to manipulate a variety of input video streams using a variety of systems to achieve the best possible results in an acceptable period of time. Currently video applications, such as a video editor, simply use the available system. Depending on the task to be performed, and other factors, such as data resolution, the system may not be configured to perform the task optimally, where optimally implies the best achievable speed with acceptable output quality.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram of a system and a video application according to an embodiment.

FIG. 2 is a diagram of a system that includes a video transcode pipeline, according to an embodiment.

FIG. 3 is a simplified version of the FIG. 2 diagram, according to an embodiment.

FIG. 4 is a diagram illustrating another possible configuration of a system, according to an embodiment.

FIG. 5 is a diagram of a system configuration, according to an embodiment.

FIG. 6 is a diagram of a system configuration, according to an embodiment.

FIG. 7 is a diagram of a system configuration, according to an embodiment.

FIG. 8 is a diagram of a system configuration, according to an embodiment.

FIG. 9 is a diagram of a system configuration, according to an embodiment.

FIG. 10 is a diagram of a system configuration, according to an embodiment.

FIG. 11 is a diagram of a system configuration, according to an embodiment.

### DETAILED DESCRIPTION

Embodiments of the invention as described herein provide a solution to the problems of conventional methods as stated above. In the following description, various examples are given for illustration, but none are intended to be limiting. Embodiments include a video driver/interface that communicates with a video processing application such as a video editor. The video driver/interface is configurable to determine a best configuration of the system in order to optimally perform the chosen video processing task. Configuration of a system includes dividing the task into subtasks and assigning the subtasks to processors of the system, including central processing units (CPUs) and graphics processing units (GPUs). Configuration of the system also includes optimizing use of available memory of different kinds.

As a non-limiting example, embodiments apply to software code on the GPU, with possible memory copies from CPU to GPU or GPU to CPU memory systems. As is known in the art, a “shader” or “shader program” is a set of software instructions, and sometimes associated hardware, used primarily to calculate rendering effects on graphics hardware with a high degree of flexibility. Shaders are used to program the GPU programmable rendering pipeline, which has mostly superseded previous fixed-function pipeline that allowed only common geometry transformation and pixel shading functions.

Embodiments as described herein account for the fact that there can be many possible hardware and software configurations, and within each configuration there can be different speeds of processors and different speeds of memory. The manner in which a GPU shader program is written can hide or expose potentially long memory latencies, and thus the organization of the shader program itself can be configured to improve or optimize overall performance.

In an embodiment, finding the best combination of shader programs for the task being performed includes testing various pre-written methods for implementing shader kernels, then choosing the most efficient method. This can be done in advance with results stored in tables, at install time, or at run-time. A combination of these can be done as well with a few choices stored in tables plus additional refinement done at install time or runtime.

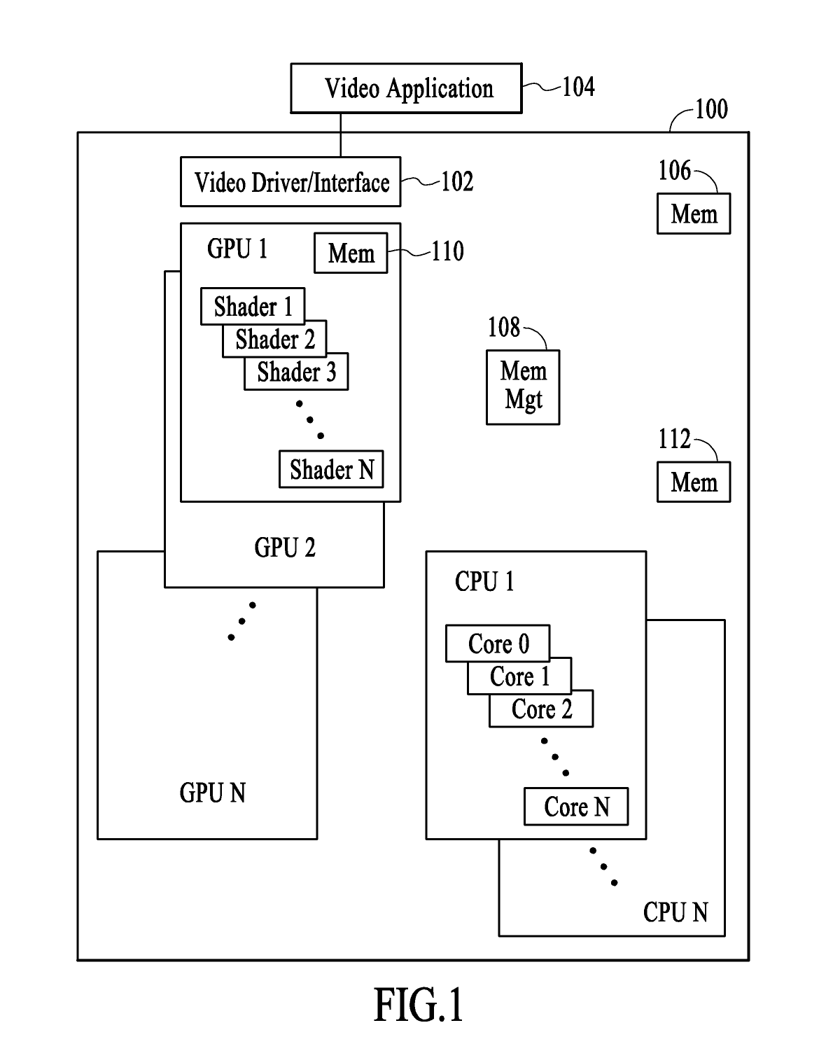

FIG. 1 is a block diagram of a system 100 and a video application 104. Video application 104 includes any software specifically for performing video data processing tasks, such as encoding, decoding, transcoding, blending, etc. System 100 includes one or more CPUs. As an example, CPU 1-CPU N are shown. Each of the CPUs may include multiple processing cores. System 100 also includes various types of memory. Memory devices or components 106 112, and 110 are shown as examples. Memory 110 is dedicated GPU memory, memory 106 may be (as an example) system memory, memory 112 can be cache memory and so on. In general, as described herein, memory components may be represented by physical components, or may be divided virtually into address spaces regardless of the actual physical location of the memory. As further described herein, embodiments determine how to efficiently use all of the types of memory in order to perform the task.

System 100 includes one or more GPUs. GPU 1-GPU N are shown by way of example. Each of the GPUs has dedicated memory and multiple shaders. As described herein, the term shader implies the software and hardware designed for specific graphics processing subtasks as known in the art.

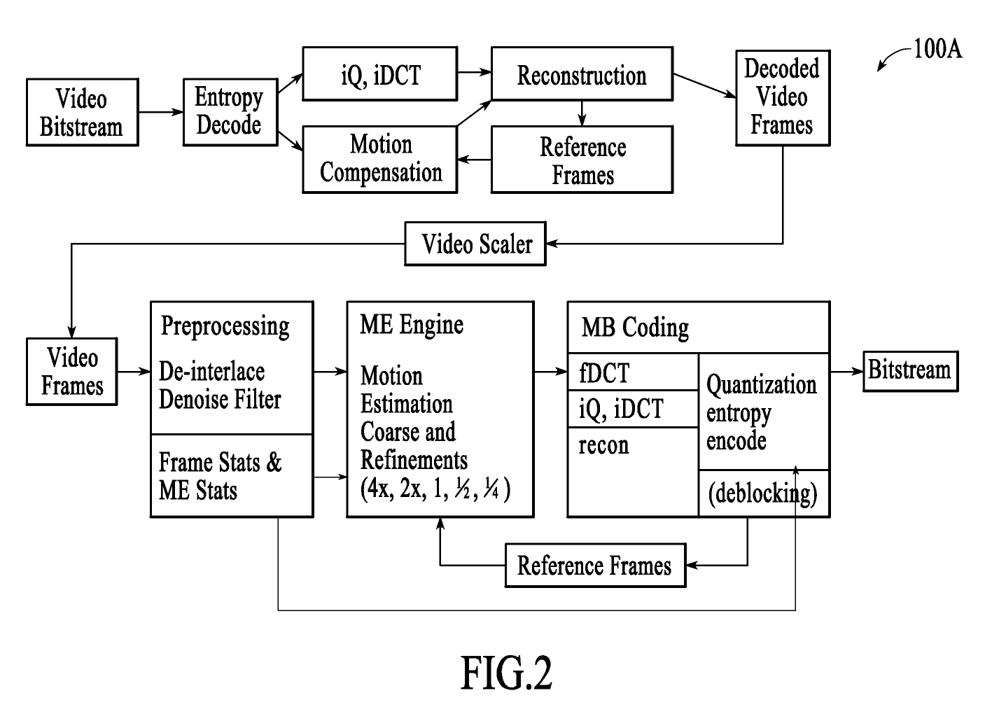

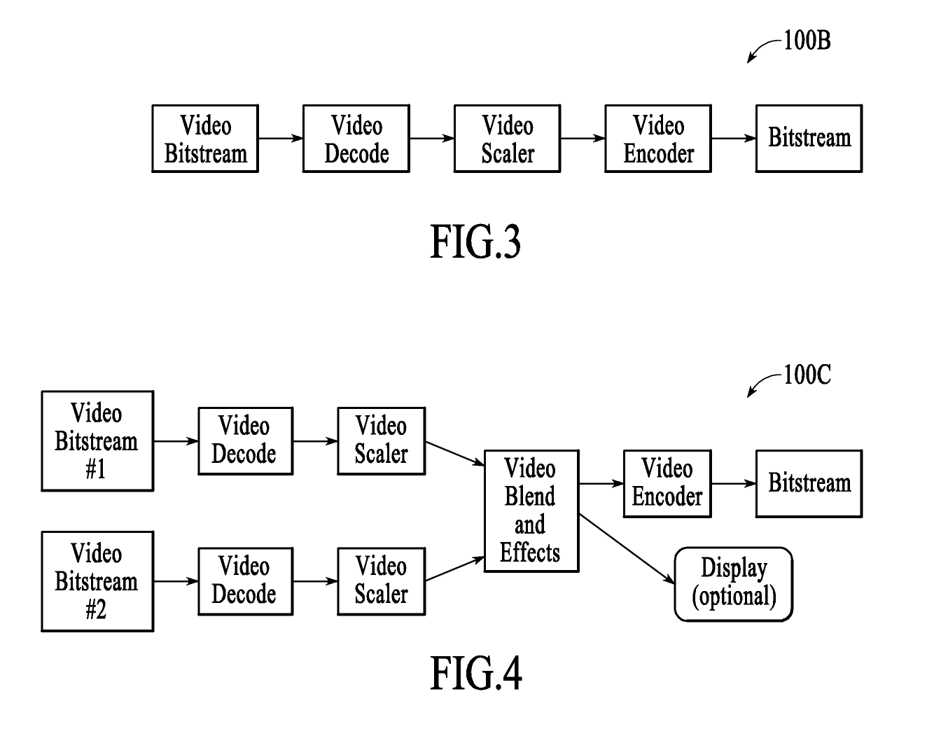

FIG. 2, FIG. 3, and FIG. 4 are each examples of many possible workload configurations for a video data processing task. FIG. 2 show a system 100A that includes a video transcode pipeline. In an embodiment, the video transcode pipeline is a worst-case type of operation that could occur on a personal computer (PC). Referring to the top row of the diagram, a video bitstream is fed to an entropy decoder. The stream then undergoes inverse quantization (iQ), inverse discrete cosine transformation (iDCT) and motion compensation. Reference frames are fed back from the reconstruction step for performing motion compensation. The result of the row operations is decoded video frames. The decoded video frames can be scaled by a video scalar.

The bottom row of the diagram illustrates encoding stages resulting in a video bitstream. Embodiments place blocks of 100A on different compute engines of the PC, including the CPU and all of its cores, the GPU with its different shared processors (e.g., reference multiple cores within CPU 1 in FIG. 1), and different shared shaders (e.g., reference multiple shaders in GPU 1 in FIG. 1), and possibly dedicated hardware specialized for a particular function.

FIG. 3 is a simplified version of the FIG. 2 diagram, showing a system 100B with the major processing items or stages shown. The major stages include an input video bitstream, decoding, scaling, encoding, and an output bitstream.

FIG. 4 is a diagram illustrating another possible configuration of a system 100C. FIG. 4 illustrates video editing with two bitstreams. System 100C shows that the relatively simple task of FIG. 3 becomes more complicated with multiple bitstreams, because there are two streams of decode tasks, some blending and encoding, and then an optional display. Each decode task (only two are shown here) multiplies the number of subtasks and the amount of data handling and memory management. In this configuration the workload balance can change radically over time. As an example, the workload balance can change as follows:

single decode, encode

dual decode, 2D blend, encode

single decode, encode

dual decode, scale, 3D effect/blend, encode

In addition, a dedicated hardware component for performing video decoding could be used as the primary decoder and the second stream decoder could be CPU software or a combination of CPU software and GPU shaders.

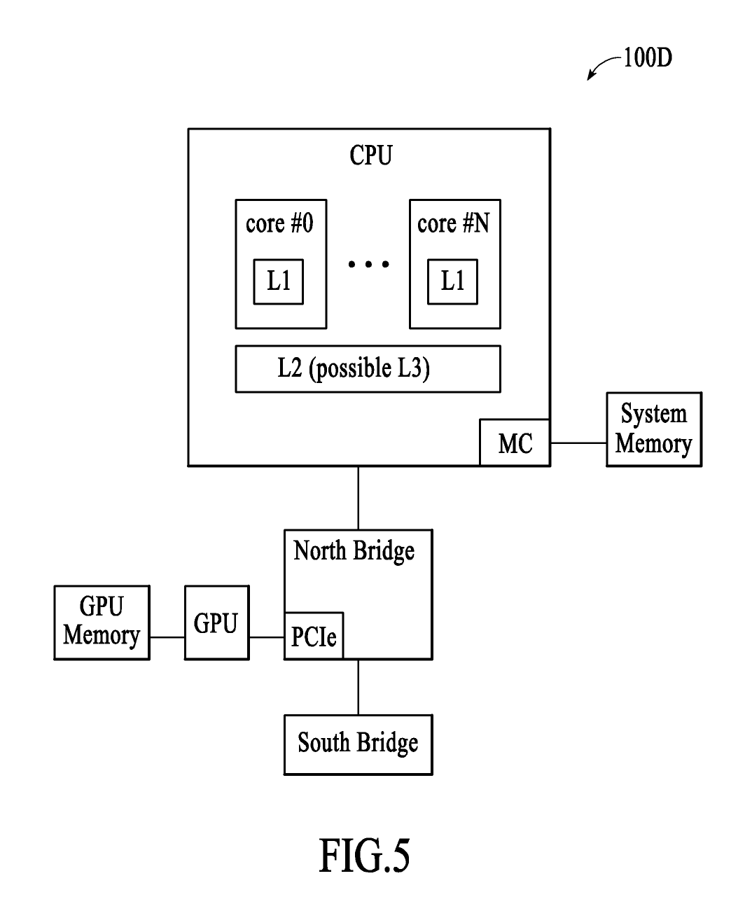

FIGS. 5-11 illustrate yet additional possible hardware configurations, although they are not exhaustive. For example, for each case showing a discrete GPU, there could also be two or more GPUs. When an integrated GPU is shown there could also be one or more additional, discrete GPU. There could be multiple CPU sockets, each with a multi-core processor. Each CPU configuration could be running at any one of several CPU speeds. Each GPU configuration could have GPUs with different clock speeds and different numbers of shader processors, and different memory sizes. There are hundreds, or possibly thousands of configurations. Embodiments of the invention enable optimization of configurations for video processing. This optimization is more complicated than typical software performance optimization in which only CPU model, speed, cache size and memory size are of much concern. For the present video processing optimization, all of the previous parameters are considered in addition to all GPU parameters, and all system architecture parameters.

FIG. 5 is a diagram of a system configuration 100D. Configuration 100D is a popular configuration today for video editing. Configuration 100D includes a standard CPU with a discrete GPU added on. The CPU includes multiple cores, a memory controller, and multiple cache levels (L1, L2, and possibly L3). The discrete GPU is connected to a North Bridge, and has its own GPU memory. Other system components such as a South Bridge and system memory are shown for completeness.

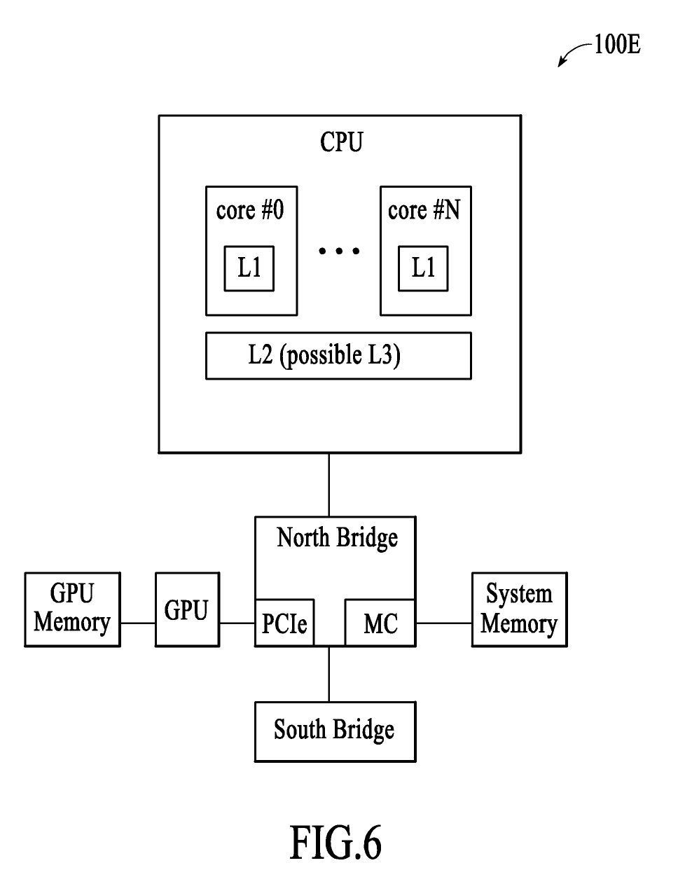

FIG. 6 shows a configuration 100E that is very similar configuration 100D, except for the fact that the memory controller is in the North Bridge. The fact that this difference exists means that data takes a different path from system to GPU memory that is different than the path of configuration 100D.

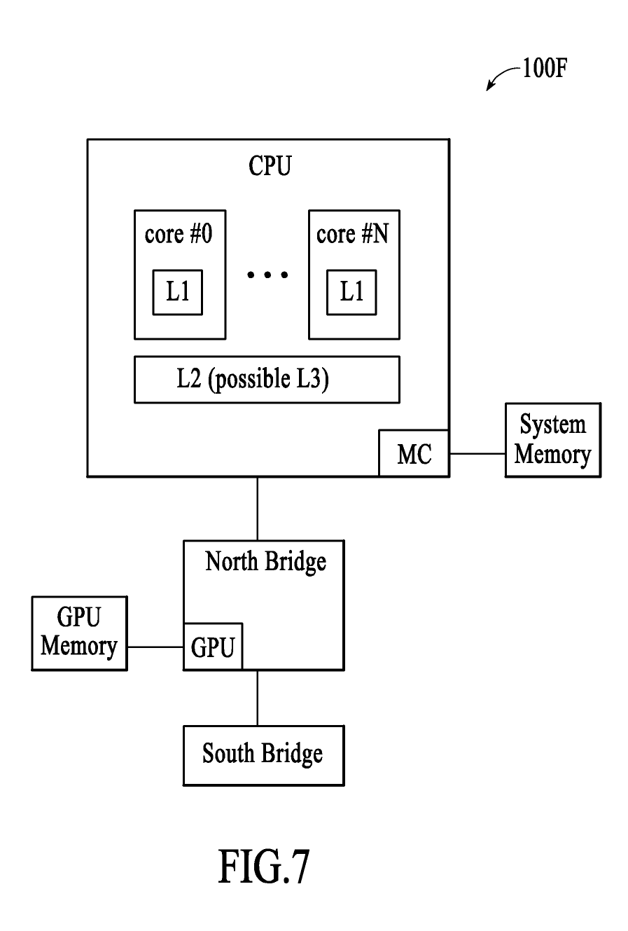

FIG. 7 shows a configuration 100F that includes an integrated GPU in the North Bridge.

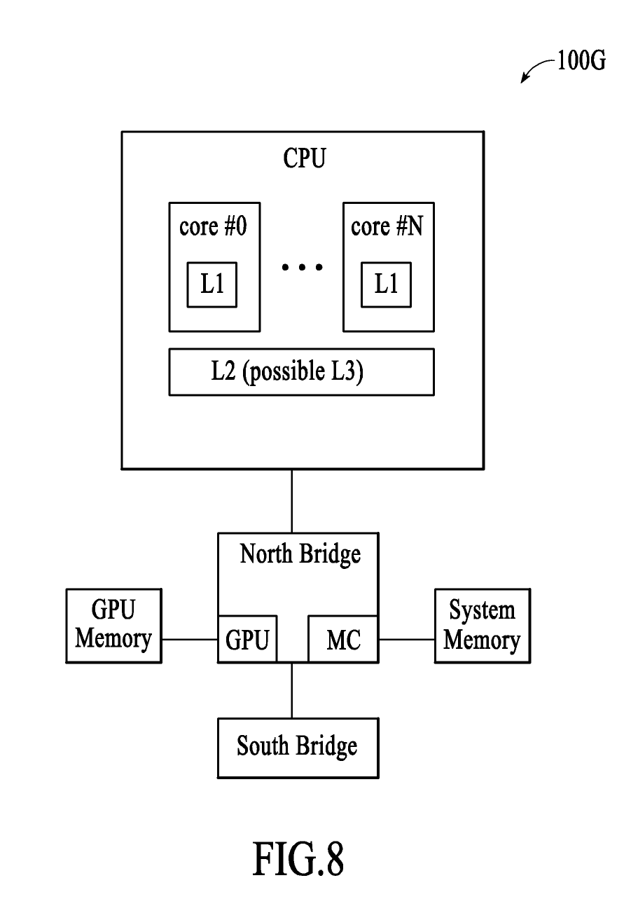

FIG. 8 shows a configuration 100G that is similar to configuration 100F, but with the memory controller in the North Bridge.

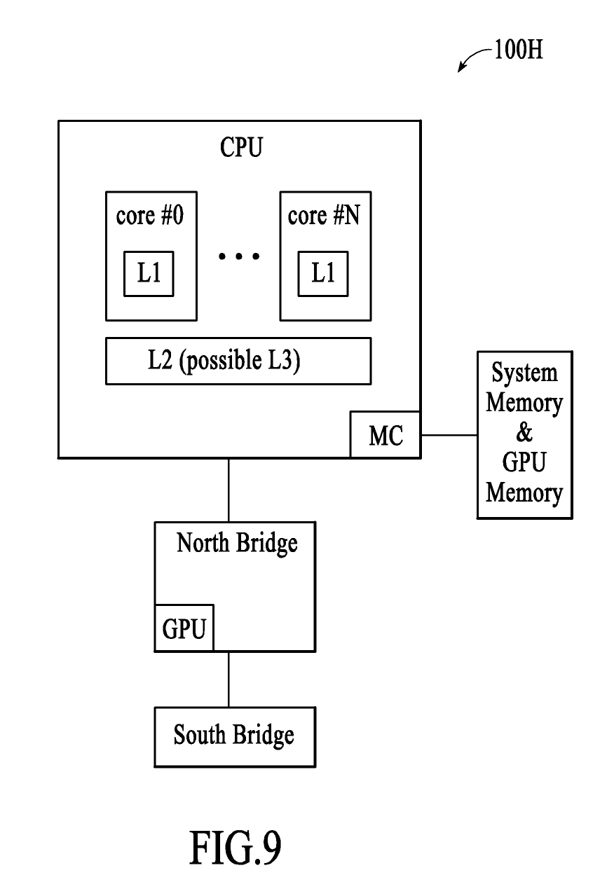

FIG. 9 shows a configuration 100H that does not include a memory for the GPU. This is known as zero frame buffer, or ZFB. The GPU memory is in the system memory. When the GPU wants to store data and/or instructions, it knows in the typical configuration that it has a GPU memory completely separate from system memory, with a separate bus, etc. In ZFB configuration, the GPU has no memory so its memory controller must go through the more tortuous path of using system memory. When the system boots up it sets aside a portion of system memory for the GPU.

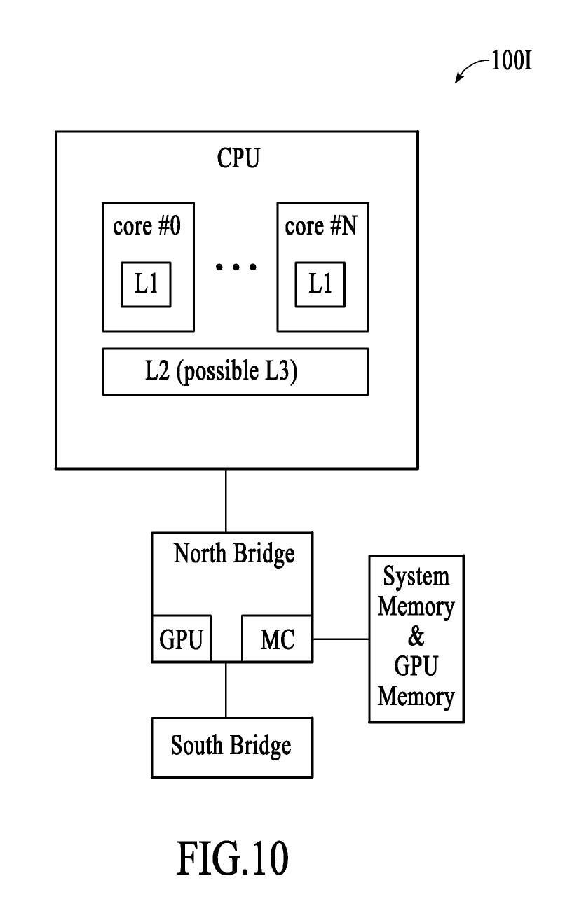

FIG. 10 shows a configuration 100I that is similar to configuration 100H, but with the memory controller in the North Bridge.

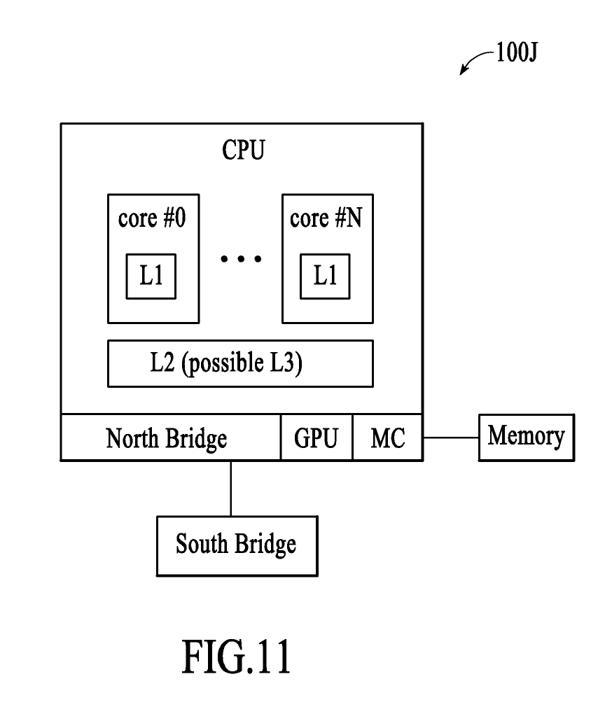

FIG. 11 shows a configuration 100J that includes a GPU, North Bridge, and a memory controller on the CPU. In an embodiment, a set of benchmark video data is run on all of the system configurations contemplated, and performance measured. The results are stored in a table. At system run time, the system is configured based on the type of system and the data in the table.

As an example, a user might want to take a DVD and convert it into a video frames for an IPOD™. There is an optimum configuration for this particular task stored in the table. In comparison, if the user is trying to do video editing with multiple input streams, and these are all high definition inputs and the desired output is also a high definition output, there is another configuration that is optimum (and that would be different from the first example). The user's desired task can include combinations of variables. For example, resolution is a variable that affects the memory bandwidth, while other variables affect the number of processing pipelines required. There can be thousands of permutations to be considered for building the table. The number of hardware configurations and the number of workloads are virtually unlimited. For this reason there is an alternative to choosing and testing a variety of configurations and workloads and build the table. Alternatively, sample loads are run through the system when the application software is installed, and from the results an estimate of optimum configuration is derived.

Embodiments contemplate many different subtask assignments for the various configurations. What follows is a non-exhaustive discussion of considerations for subtask assignment according to embodiments.

Currently in a computing device (which may be defined by several terms including, but not limited to a PC, a laptop, a portable device, a server etc.; hereinafter “PC” and “computing device” are used interchangeably), there are several ways to perform decoding. One way is to decode completely in software using the PC. Another way is to share the CPU with the GPU. For example, the CPU does the first half of decoding, builds tables, and then sends the remainder of the work to the GPU where the final step is done.

Then there several ways the second part of decoding has been done in GPUs over the last ten years. One way is to dedicate hardware on the GPU to perform parts of the pipeline. The iDCT is typically done on dedicated hardware and the motion compensation and reconstruction is either done in dedicated hardware, or in the more modern graphics chips, in shader processors.

Alternatively, decoding tasks can be done on the shared processors. A third way to perform video decoding is to build a complete video decoder in hardware and place it in the GPU. For example, AMD® offers such a special purpose decoder. Software still looks at the bitstream that comes in, and it sends each frame to the decoder, which then decodes the video. This has the advantage of relieving the CPU of workload.

Considering only decoding, there several methods possible. The methods can also be combined. For example, the special purpose decoder can be combined with software, process different proportions of the same stream.

Another consideration given the configurations shown in FIGS. 5-11 is whether a memory bus is being overloaded in the process of transferring data among the memories and processing components. In an embodiment, small data samples for a task are run on each configuration in order to see whether a memory bus is being overloaded.

The foregoing discussion regarding considerations for decoding is also applicable to scaling.

Scaling can be done in two places in the configurations shown, although alternatively one could also build a hardware scaler with similar capabilities. Typically GPU shaders (rather than hardware scalers) are used because they are efficient scalers. Scaling in the CPU, the GPU, or both.

Encoding can be done in CPU, GPU or shared between them. When encoding is done in the CPU it is typically some shared method, such as shared between GPU(s) and CPU. Video encoding can also be done in a dedicated hardware block or component.

For video editing tasks, embodiments of the present invention may consider the number of video data input streams, and whether the streams are being previewed or actually output. The video streams are then blended and encoded (see for example FIG. 4, “Video Blend and Effects”). The encoded output desired may be a draft output (that is, of relatively low quality) because the user just wants a sketch of what blended image will look like. There are many possible ways of blending video input streams, and in one embodiment there are up to sixteen possible video data input streams. For video editing, what is implicated is the layer of software below the video editor. The video editor requests data. Currently what most video editing is done using software. Some vendors might use hardware in the graphics chip that accelerates the display. Embodiments as described herein, in contrast, accelerate the entire editing process on general purpose systems that include not dedicated graphics acceleration elements.

Although embodiments have been described with reference to systems comprising GPU devices, which are dedicated or integrated graphics rendering devices for a processing system, it should be noted that such embodiments can also be used for many other types of video production engines that are used in parallel. Such video production engines may be implemented in the form of discrete video generators, such as digital projectors, or they may be electronic circuitry provided in the form of separate IC (integrated circuit) devices or as add-on cards for video-based computer systems.

In one embodiment, the system including the GPU system comprises a computing device that is selected from the group consisting of: a personal computer, a workstation, a handheld computing device, a digital television, a media playback device, smart communication device, and a game console, or any other similar processing device.

Aspects of the system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects of the video stream migration system may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the video stream migration system is not intended to be exhaustive or to limit the embodiments to the precise form or instructions disclosed. While specific embodiments of, and examples for, processes in graphic processing units or ASICs are described herein for illustrative purposes, various equivalent modifications are possible within the scope of the disclosed methods and structures, as those skilled in the relevant art will recognize.

The elements and acts of the various embodiments described above can be combined to provide further embodiments. These and other changes can be made to the disclosed system in light of the above detailed description.

In general, in the following claims, the terms used should not be construed to limit the disclosed method to the specific embodiments disclosed in the specification and the claims, but should be construed to include all operations or processes that operate under the claims. Accordingly, the disclosed structures and methods are not limited by the disclosure, but instead the scope of the recited method is to be determined entirely by the claims.

While certain aspects of the disclosed embodiments are presented below in certain claim forms, the inventors contemplate the various aspects of the methodology in any number of claim forms. For example, while only one aspect may be recited as embodied in machine-readable medium, other aspects may likewise be embodied in machine-readable medium. Accordingly, the inventor reserves the right to add additional claims after filing the application to pursue such additional claim forms for other aspects.

What is claimed is:

1. A video processing system comprising:
a plurality of processors, said plurality of processors comprising:
one or more central processing units (CPUs);
one or more graphics processing units (GPUs); and
a video data processing driver/interface configurable to,
determine a current configuration of the system, including the number and types of processors;
determine an optimum workload assignment for a video data processing task, comprising assigning subtasks among said plurality of processors; and
execute the video processing task according to the determined workload assignment.

2. The system of claim 1, further comprising:
a plurality of memory devices, comprising memory devices with various access paths and various access protocols, wherein the video data processing driver/interface is further configured to determine an optimum memory configuration for the video data processing task.

3. The system of claim 2, wherein the video data processing driver/interface is further configurable to transfer data among memory partitions, including transferring data between partitions within a memory address space that includes different performance characteristics.

4. The system of claim 1, wherein the video data processing task comprises decoding, encoding transcoding, editing, dual encoding, blending, and scaling.

5. The system of claim 1, wherein each of the one or more CPUs comprises a plurality of processing cores.

6. The system of claim 1, wherein each of the one or more GPUs comprises a plurality of shaders.

7. The system of claim 1, wherein the subtasks are executed concurrently on a combination of CPU processing cores and GPU shaders.

8. A method for processing video data, the method comprising:
determining a configuration of a system that is to perform video data processing;
determining a video data processing task to be performed by the system;
based on the system configuration and the task, dividing the task into a plurality of subtasks; and
determining an optimum assignment of subtasks to system processing components, wherein the components comprise central processing unit (CPU) cores, graphics processing unit (GPU) compute engines, and a plurality of memory subsystems.

9. The method of claim 8, wherein determining the optimum assignment of subtasks comprises executing test code to find the optimum assignment.

10. The method of claim 8, wherein the optimum assignment comprises a method of balancing data transfers between memory subsystems.

11. The method of claim 10, wherein the memory subsystems comprises system memory, and GPU-dedicated memory.

12. The method of claim 11, further comprising transferring data between partitions within a memory address space that includes different performance characteristics

13. The method of claim 9, wherein executing test code comprises pre-configuring video processing software for a particular system by running tests on numerous dissimilar systems, and storing the results in a table to be used at runtime.

14. The method of claim 9 wherein executing test code comprises performing an install-time test to determine an existing system configuration to enable selection of appropriate video processing methods to be used.

15. The method of claim 8, wherein the video data processing task comprises decoding, encoding transcoding, editing, dual encoding, blending, and scaling.

16. A computer-readable medium having stored thereon instruction, that when executed in a system cause a method for processing video data to be performed, the method comprising:
determining a configuration of a system that is to perform video data processing;
determining a video data processing task to be performed by the system;
based on the system configuration and the task, dividing the task into a plurality of subtasks; and
determining an optimum assignment of subtasks to system processing components, wherein the components comprise central processing unit (CPU) cores, graphics processing unit (GPU) compute engines, and a plurality of memory subsystems.

17. The medium of claim 16, wherein determining the optimum assignment of subtasks comprises executing test code to find the optimum assignment.

18. The medium of claim 16, wherein the optimum assignment comprises a method of balancing data transfers between memory subsystems.

19. The medium of claim 18, wherein the memory subsystems comprises system memory, and GPU-dedicated memory.

20. The medium of claim 19, wherein the method further comprises transferring data between partitions within a memory address space that includes different performance characteristics

21. The medium of claim 17, wherein executing test code comprises pre-configuring video processing software for a particular system by running tests on numerous dissimilar systems, and storing the results in a table to be used at runtime.

22. The medium of claim 17 wherein executing test code comprises performing an install-time test to determine an existing system configuration to enable selection of appropriate video processing methods to be used.

23. The medium of claim 16, wherein the video data processing task comprises decoding, encoding transcoding, editing, dual encoding, blending, and scaling.
